(19) United States
(12) Patent Application Publication
(10) Pub. No.: US 2015/0111173 A1
(43) Pub. Date: Apr. 23, 2015

(54) METHOD OF MAKING A DENTAL RESTORATION THAT INHIBITS TOOTH DEMINERALIZATION

(71) Applicants: Yunoh Jung, Sandy, UT (US); Daniel Yonil Jung, Sandy, UT (US)

(72) Inventors: Yunoh Jung, Sandy, UT (US); Daniel Yonil Jung, Sandy, UT (US)

(21) Appl. No.: 14/452,199

(22) Filed: Aug. 5, 2014

Related U.S. Application Data
(63) Continuation-in-part of application No. 14/292,601, filed on May 30, 2014.
(60) Provisional application No. 61/892,345, filed on Oct. 17, 2013.
(60) Provisional application No. 61/909,812, filed on Nov. 27, 2013.

(51) Int. Cl. A61C 13/00; A61C 5/10; A61C 13/08; A61C 8/00

(52) U.S. Cl. CPC A61C 13/0006; A61C 8/0012; A61C 5/10; A61C 13/082; A61C 13/0003
USPC 433/173; 433/219; 433/172; 264/17

(57) ABSTRACT

A method for making a dental restoration comprises fabricating a dental workpiece from a pre-sintered dental ceramic material; sintering the dental workpiece defining a sintered dental workpiece; applying a demineralization-inhibiting material inside the pocket or hole of the workpiece; and hardening the demineralization-inhibiting material defining a hardened demineralization-inhibiting portion with an exposed surface exposed in an opening in the sintered dental workpiece.

### PRIORITY CLAIM

This is a continuation-in-part of copending U.S. patent application Ser. No. 14/292,601, filed May 30, 2014; which claimed priority to copending U.S. Provisional Patent Application Ser. No. 61/892,345, filed Oct. 17, 2013, and 61/909,812, filed Nov. 27, 2013; which are hereby incorporated herein by reference in their entirety.

### BACKGROUND

1. Field of the Invention

The present invention relates generally to a method for making a dental prosthesis or restoration, such as a dental crown, bridge, in-lay or on-lay restoration.

2. Related Art

Dental ceramics can be classified according to their crystalline phase and fabrication technique. Crystalline phase may be; Leucite, lithium disilicate, alumina, spindle, alumina-zirconia, zirconia (3Y-TZP) (Ceramics for dental applications: A Review, Isabelle Denry and Julie Holloway, Materials 2010, 3, 351-368). This classification is constantly evolving with latest developments leading to the combination of several fabrication techniques and core/veneering ceramic systems, with the ultimate goal of achieving adequate strength and toughness, optimal esthetics and long-term in vivo performance.

Ceramics are much valued, because of their physical properties, in the construction of high-quality dental restorations. Aluminium and zirconium oxide ceramics have long been the materials of choice in the medical field. By ceramics and dental ceramics are meant here all high-strength oxides of the elements of the main groups II, III and IV and the subgroups III and IV as well as their mixtures, in particular Al2O3, ZrO2, both partly and also fully stabilized, MgO, TiO2 and their mixtures.

Metal-ceramic systems for dental restorations have been available since the 1960s. They rely on the application and firing of a veneering ceramic onto a metal substructure to produce an esthetically acceptable restoration. Veneering ceramics for metal-ceramic restorations—commonly named feldspathic porcelains—are usually leucite-based.

Leucite (KAISi2O6) is a potassium alumino-silicate that exhibits a tetragonal structure at room temperature and undergoes a displacive phase transformation from tetragonal to cubic at 625° C., accompanied with a volume expansion of 1.2%.

Feldspathic dental porcelains usually contain between 15 and 25 vol % leucite. This amount is adjusted so that the coefficient of thermal contraction of the porcelain is slightly lower than that of the metal, in order to place the ceramic under slight compression. Veneering ceramics for dental restorations are classically sintered under vacuum in order to reduce the porosity of the final product.

### SUMMARY OF THE INVENTION

It has been recognized by the present inventors that it would be advantageous to develop a dental prosthesis, such as dental crown or bridge restoration, and method for making the dental prosthesis, that is capable of inhibiting adjacent teeth from loosing enamel, and/or capable of resisting demineralization of adjacent teeth, and/or capable of promoting re-mineralization of adjacent teeth.

The invention presents a method for making a dental restoration configured to receive and match a prepared tooth or an implant abutment, the method comprising, in sequence, the steps of:
a) receiving a margin line information of the prepared tooth or the implant abutment; followed by
b) designing a dental workpiece; followed by
c) fabricating the dental workpiece from a pre-sintered dental ceramic material shaped to match the prepared tooth or the implant abutment, and a pocket or hole in an exterior surface thereof; followed by
d) sintering the dental workpiece; followed by
e) applying a demineralization-inhibiting material inside the pocket or hole of the workpiece; followed by
f) hardening the demineralization-inhibiting material while outside a patient's mouth to form a final restoration.

In addition, the invention provides a method for making a dental restoration configured to receive and match a prepared tooth or an implant abutment, the method comprising, in sequence, the steps of:
a) receiving a margin line information of the prepared tooth or the implant abutment; followed by
b) designing at least part of a dental workpiece; followed by
c) fabricating the dental workpiece from a pre-sintered dental ceramic material shaped to match the prepared tooth or the implant abutment; followed by
d) sintering the dental workpiece; followed by
e) creating at least an outside contour of a body of the restoration including a pocket or hole in the outside contour; followed by
f) heat treating the body to have a final strength; followed by
g) applying a demineralization-inhibiting material inside the pocket or hole of the body; followed by
h) hardening the demineralization-inhibiting material while outside a patient's mouth to form a final restoration.

Furthermore, the invention provides a method for making a dental crown or bridge restoration configured to receive and match a prepared tooth or an implant abutment, the method comprising:
a) fabricating a dental workpiece from a pre-sintered dental ceramic material to have occlusal, mesial side, buccal, distal side, and lingual walls, with the buccal wall configured to be adjacent a patient's cheek, and the lingual wall configured to be adjacent a patient's tongue, the occlusal wall configured to face an opposing tooth, the mesial and the distal side walls each configured to face a different adjacent tooth, and a margin line configured to match a margin line of the prepared tooth or the implant abutment, and a concavity opposite the occlusal wall and between the walls and configured to receive and match the prepared tooth or the implant abutment, and a pocket or hole in one of the walls and the concavity and with an opening in the exterior surface;
b) sintering the dental workpiece defining a sintered dental workpiece;
c) applying a demineralization-inhibiting material inside the pocket or hole of the workpiece; and
d) hardening the demineralization-inhibiting material defining a solid and hardened demineralization-inhibiting portion at least filling the pocket or hole and with an exposed surface exposed in the opening in the sintered dental workpiece, the sintered dental workpiece and the hardened demineralization-inhibiting portion together forming the crown or bridge restoration.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1a is a perspective view of a portion of a patient's mouth and teeth, or a dental stone model representing the patient's teeth, including a prepared tooth that has been cut to receive a dental prosthesis or restoration;

FIG. 1 b is a side view of a portion of the patient's mouth and teeth with a dental crown restoration of FIG. 3 in accordance with an embodiment of the present invention seated on the prepared tooth;

FIG. 2 is an exploded side view of a sectioned dental stone model with a dental crown restoration of FIG. 3;

FIG. 3 is a side view of a dental prosthesis or restoration, namely a dental crown restoration, in accordance with an embodiment of the invention;

FIG. 4 is a side view of a dental implant with an implant abutment and receiving a dental crown restoration of FIG. 3 in accordance with the invention;

FIG. 5 is an exploded side view of the dental implant with the implant abutment receiving the dental crown restoration thereon of FIG. 3;

FIGS. 6a-c are top views and

FIGS. 7a-c are cross-sectional side views of a method for making a dental crown or bridge restoration; with FIG. 6a being a top view and FIG. 7a being a cross-sectional side view of a dental workpiece of pre-sintered dental ceramic including a concavity sized and shaped to receive and match the prepared tooth or the implant abutment, and a pocket or hole in an exterior surface thereof; with FIG. 6b being a top view and FIG. 7b being a cross-sectional side view of the dental workpiece after sintering; and with FIG. 6c being a top view and FIG. 7c being a cross-sectional side view of the sintered dental workpiece with a demineralization-inhibiting material applied and hardened inside the pocket or hole of the workpiece;

FIG. 8 is a flow diagram of a method for making a dental crown or bridge restoration in accordance with an embodiment of the present invention;

FIG. 9 is a flow diagram of a method for making a dental crown or bridge restoration in accordance with an embodiment of the present invention;

FIGS. 10a-d are cross-sectional side views of another method for making a dental crown or bridge restoration; with FIG. 10a being a cross-sectional side view of a dental workpiece, or substructure, coping or framework, of pre-sintered dental ceramic including a concavity sized and shaped to receive and match the prepared tooth or the implant abutment; with FIG. 10b being a cross-sectional side view of a body formed on a sintered dental workpiece, or substructure, coping or framework; with FIG. 10c being a cross-sectional side view of the body on the sintered dental workpiece, or substructure, coping or framework, and with a pocket or hole in an exterior surface thereof; and FIG. 10d being a cross-sectional side view of the sintered dental workpiece with a demineralization-inhibiting material applied and hardened inside the pocket or hole of the workpiece;

FIG. 11 is a flow diagram of a method for making a dental crown or bridge restoration in accordance with an embodiment of the present invention;

FIG. 12 is a side schematic view of the dental workpiece, or the body, with a dental bur forming the pocket or hole;

FIG. 13 is an exploded side view of a sectioned dental stone model with a dental prosthesis or restoration, namely a bridge, in accordance with an embodiment of the invention;

FIGS. 14a-14d are top views of another method for making a dental prosthesis or restoration, namely an in-lay restoration; with FIG. 14a being a top view of a prepared tooth; with FIG. 14b being a top view of a dental workpiece of pre-sintered dental ceramic sized and shaped to match the prepared tooth, and a pocket or hole in an exterior surface thereof; with FIG. 14c being a top view of the dental workpiece after sintering with a demineralization-inhibiting material applied and hardened inside the pocket or hole of the workpiece; and FIG. 14d is a top view of the prepared tooth with the in-lay restoration thereon; and

FIGS. 15a-d are top views of another method for making a dental prosthesis or restoration, namely an on-lay restoration; with FIG. 14a being a top view of a prepared tooth; with FIG. 14b being a top view of a dental workpiece of pre-sintered dental ceramic sized and shaped to match the prepared tooth, and a pocket or hole in an exterior surface thereof; with FIG. 14c being a top view of the dental workpiece after sintering with a demineralization-inhibiting material applied and hardened inside the pocket or hole of the workpiece; and FIG. 14d is a top view of the prepared tooth with the on-lay restoration thereon.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENT(S)

### Definition of the Terms

Re-mineralization. At physiological conditions, the oral fluids (saliva, biofilm fluid) have calcium (Ca) and phosphate (Pi) in supersaturated concentrations with respect to the mineral composition of enamel of teeth and, as a result, these ions (PO43−, Ca2+) are continually deposited on the enamel surface or are re-deposited in enamel areas where they were lost. This can be considered a natural defense phenomenon promoted by saliva to preserve the mineral structure of enamel in the mouth. Therefore, re-mineralization can be defined as the re-deposition of minerals lost by enamel, and this term has been used as a synonymous of enamel repair or rehardening. (Jaime Aparecido Cury, Enamel demineralization, Braz Oral Res 2009; 23 (Spec Iss 1): 23-30).

De-mineralization. Mineral loss (demineralization) or gain (re-mineralization) by enamel is a dynamic physicochemical process occurring when oral bacteria form a biofilm on the enamel surface, and this biofilm is exposed to fermentable dietary carbohydrates, sucrose being the most cariogenic of them. Thus, every time sugar penetrates into a cariogenic biofilm and is converted to acids by bacterial metabolism, the biofilm fluid becomes undersaturated with respect to the enamel mineral, and demineralization occurs. A critically low pH for tooth dissolution is maintained for a certain time, but it returns to physiological values when exposure to sugar ceases. Therefore, when the pH is raised and the supersaturating conditions are restored, a certain amount of the mineral lost can be recovered by enamel. This process has been named re-mineralization. Re-deposition of the mineral lost by enamel can occur by Ca and Pi found in the biofilm fluid or by direct action of salivary Ca and Pi soon after the biofilm is removed by tooth brushing. The amount of Ca and Pi gained, however, is lower than that lost, and the net result is a small mineral loss. If the factors responsible for the disease—biofilm accumulation and frequent sugar exposure—are not controlled, enamel mineral loss cannot be stopped. Repeated events of mineral dissolution will eventually surpass the capacity of oral fluids to repair mineral loss, and the disease will show its first clinical signs: white spot lesions.

Direct restoration: a restoration made directly in the patient's mouth by the dentist, not by a dental technician outside of the mouth.

Indirect restoration: a restoration made outside of the patients mouth, usually in the dental laboratory.

Crown: an indirect dental restoration with mesial side, buccal, distal side, lingual and occlusal walls connected to form a concavity therein, and the concavity contacting a prepared tooth cut by a dentist, or an implant abutment. Inlays and onlays are not dental crowns since they do not have all five cap walls consisting of mesial side, buccal, distal side, lingual and occlusal walls. A bridge is a multiple tooth dental crown. The filling of material onto the human tooth (a “filling”) is done directly inside the patient's mouth and is not a dental crown. The term crown is used herein to include bridge for simplicity of discussion. In addition, the terms dental prosthesis, dental restoration, final restoration, restoration crown, restoration bridge, crown and bridge are used interchangeably herein.

In-lay (or inlay) and On-lay (or onlay): a dental restoration that is received in a cut-out or indentation cut into the prepared tooth by a dentist, with the cut-out or indentation and the in-lay generally in a side (mesial, distal, buccal, lingual) of the prepared tooth, and with the cut-out or indentation and the on-lay generally includes a cusped or corner of the prepared tooth. Thus, the in-lay or on-lay can have an exterior side surface, and an exterior top (occlusal) surface.

Mesial or mesial side: Situated toward the middle of the front of the jaw along the curve of the dental arch. The direction towards the anterior midline in a dental arch, as opposed to distal or distal side, which refers to the direction towards the last tooth in each quadrant. Each tooth can be described as having a mesial surface and, for posterior teeth, a mesiobuccal (MB) and a mesiolingual (ML) corner or cusp. Both mesiobuccal and mesiolingual are regarded as a part of the mesial area of a crown throughout the application of this invention.

Distal or distal side: Situated farthest from the middle and front of the jaw towards the throat. The opposite side of mesial side. The direction towards the last tooth in each quadrant of a dental arch, as opposed to mesial or mesial side, which refers to the direction towards the anterior midline. Each tooth can be described as having a distal surface and, for posterior teeth, a distobuccal (DB) and a distolingual (DL) corner or cusp. Both distobuccal and distolingual are regarded as a part of the distal area of a crown throughout the application of this invention.

Lingual side: a side of a crown the tongue touches in the closed bite position. The side of a tooth adjacent to (or the direction towards) the tongue, as opposed to buccal, labial, or facial which refer to the side of a tooth adjacent to (or the direction towards) the inside of the cheek or lips, respectively.

Buccal side: a side of a crown the cheek touches in the closed bite position. The opposite side of the lingual side. The side of a tooth that is adjacent to (or the direction towards) the inside of the cheek, as opposed to lingual or palatal, which refer to the side of a tooth adjacent to (or the direction towards) the tongue or palate, respectively. Although technically referring only to posterior teeth (where the cheeks are present instead of lips, use of this term may extend to all teeth, anterior and posterior), this term may be employed to describe the facial surface of (or directions in relation to) anterior teeth as well.

Labial: The side of a tooth that is adjacent to (or the direction towards) the inside of the lip, as opposed to lingual or palatal, which refer to the side of a tooth adjacent to (or the direction towards) the tongue or palate, respectively. Although technically referring only to anterior teeth (where the lips are present instead of cheeks), use of this term may extend to all teeth, anterior and posterior.

Occlusal side: top surface of a crown. The surface of a crown that opposes the opposing arch. The occlusal wall of a crown contacts the other occlusal surface of the tooth of the opposing arch in closed bite position.

Margin line: the “margin” 17 of a cut tooth 2 (FIG. 3) or an implant abutment 2′ (FIG. 2d) is a circumferential line created after the tooth preparation, or manufactured on the implant abutment. The margin line of a cut tooth exists either slightly over (supra-gingival), or along, or slightly below (sub-gingival) the gum line. The crown margin line is a circumferential line corresponding to the margin line of a cut tooth.

Preparation, prep, cut(ting), grind(ing) of a tooth can be interchangeably used to mean grind away at least a portion of a tooth to make a restoration.

Hardenable, cureable, polymerization and related terms refer to a paste-like or liquid-like material being able to harden and form a solid. The term “monomer” refers to a liquid that can be hardened to form a polymer.

Glaze: A layer or coating of a vitreous substance which has been fused to a ceramic crown through firing at a temperature of 500-1,100° C.

Glazing: High temperature firing of the crown for a shiny or polished effect.

Pre-sintered: Partly sintered (or pre-sintered) alumina-based ceramics produced by dry pressing, followed by final sintering have been available since the early 1990s and are still currently used. The technique involves computer aided production of an enlarged die in order to compensate for sintering shrinkage (12 to 20%). Dry pressing and sintering of a high purity alumina-based core ceramic is then performed at high temperature (1550° C.). This leads to a highly crystalline ceramic with a mean grain size of about 4 micrometers and a measured flexural strength of 601±73 MPa. (Andersson, M.; Oden, A. A new all-ceramic crown. A dense-sintered, high-purity alumina coping with porcelain. Acta Odontol. Scand. 1993, 51, 59-64.)

Computer Aided Design/Computer Aided Design (CAD/CAM) technology was introduced in dentistry by Duret in the early 70's. The technology was originally intended for fully sintered ceramic blocs (hard machining), it has now been expanded to partially sintered (or pre-sintered) ceramics (soft machining), that are later fully heat treated to ensure adequate sintering.

Soft-machining of partially sintered (or pre-sintered) zirconia ceramic blocs by CAD/CAM technology, to produce dental restorations was proposed in 1998 by 3M in Germany. The design compensates for the volume shrinkage that will later occur during final sintering of the zirconia blocs (about 25%). Briefly, the die or a wax pattern is scanned, an enlarged restoration is designed by computer software (CAD) and a pre-sintered ceramic blank is milled by computer aided machining. The restoration is then sintered at high temperature. The partially sintered (or pre-sintered) blocs are easy to mill, which leads to substantial savings in time and tool wear. The type of zirconia used in this technology is biomedical grade tetragonal zirconia stabilized with 3 mol % yttria (3Y-TZP).

Pre-sintering temperature would vary from 600 to 1150° C., and currently available 3Y-TZP ceramics for soft machining of dental restorations require final sintering temperatures varying from 900 to 1600° C. and durations from 1 to 6 hours, depending on the manufacturer.

As used herein, “a” or “an” means “at least one” or “one or more” unless otherwise indicated.

For a better understanding of the present invention, together with other and further objects, reference is made to the following description, taken in conjunction with the accompanying drawings, and its scope will be pointed out in the appended claims.

### Description

The inventors of the present invention have realized that it would be advantageous to develop a dental prosthesis or restoration, such as a dental crown 10 or bridge 110 or in-lay 210 or on-lay 310 restoration, and method for making the dental prosthesis or restoration, that is capable of inhibiting adjacent teeth from loosing enamel, and/or capable of resisting demineralization of adjacent teeth, and/or capable of promoting re-mineralization of adjacent teeth. The present invention presents a method for making a dental crown 10 (or 10b) or bridge 110 or in-lay or on-lay restoration by fabricating a dental workpiece 5′ from a pre-sintered dental ceramic material (such as zirconia); sintering the dental workpiece defining a sintered dental workpiece 5; applying a demineralization-inhibiting material 7 inside a pocket or hole 9 of the workpiece; and hardening the demineralization-inhibiting material defining a hardened demineralization-inhibiting portion with an exposed surface exposed through the pocket or hole in the sintered dental workpiece. The exposed surface of the demineralization-inhibiting material can release ions or otherwise resist demineralization, and/or promote re-mineralization, of adjacent teeth.

The production of saliva in the mouth is a naturally occurring function that provides a restorative role for the teeth or tooth enamel. Demineralization and re-mineralization of tooth enamel takes place constantly. The tooth surface is easily colonized by bacteria to form dental plaque, especially in minute fissures or spaces between the teeth where a toothbrush cannot reach. Enamel is made up of closely packed hydroxyapatite rods separated by tiny channels about 50 nanometers wide. Acids produced by plaque bacteria seep into these channels and can dissolve the rods, causing the enamel to become demineralized.

Saliva plays a protective role. It not only neutralizes acids caused by plaque bacteria, but also provides calcium and phosphate ions—the building blocks of hydroxyapatite—which diffuse back into the enamel to restore lost mineral, so that the enamel becomes re-mineralized.

If demineralization and re-mineralization balance each other at the tooth surface, no net loss of mineral occurs. But conditions such as excess plaque, inadequate saliva flow, or heavy intake of acidic foods can tip the balance in favor or demineralization

The hydroxyapatite of tooth enamel is primarily composed of phosphate ions (PO₄³⁻) and calcium ions (Ca²⁺). Under normal conditions, there is a stable equilibrium between the calcium and phosphate ions in saliva and the crystalline hydroxyapatite that comprises 96% of tooth enamel. When the pH drops below a critical level (5.5 for enamel, and 6.2 for dentin), it causes the dissolution of tooth mineral (hydroxyapatite) in a process called demineralization. When the pH is elevated by the natural buffer capacity of saliva, mineral gets reincorporated into the tooth through the process of re-mineralization.

When the pH on the tooth surface becomes acidic, phosphate in oral fluids combines with hydrogen ions (H+) to form hydrogen phosphate species. Under these conditions, phosphate is “pulled” from tooth enamel to restore phosphate levels in the saliva, and the hydroxyapatite dissolves. As pH returns to normal, the calcium and phosphate in saliva can recrystallize into the hydroxyapatite, re-mineralizing the enamel.

As indicated above, the present invention provides a method for making a dental crown 10 and/or 10b, or bridge 110, or in-lay 210, or on-lay 310, restoration to receive and match the prepared tooth 2 or an implant abutment 27 comprising a dental workpiece 5′ fabricated from a pre-sintered dental ceramic material; and with a demineralization-inhibiting material 7 inside the pocket or hole 9 in the dental workpiece, after the dental workpiece has been sintered (defining a sintered dental workpiece 5). Thus, the restoration maintains adequate strength and aesthetics, while providing a demineralization-inhibiting material in the pocket or hole. The description will focus on a crown 10 with the understanding that such description applies to a bridge 110 as well. The method includes forming a dental workpiece 5′, or substructure 55′ and body 60, based on a scan, mold, or model of the patient's teeth 1. A patient's tooth may be cut to form a prepared or cut tooth 2 to receive the crown 10. Or the crown can be disposed on an implant 25 with an implant abutment 27. The dental workpiece 5′, substructure 55′, or crown 10 or 10b is formed with a concavity 16 therein to receive the prepared tooth 2 or implant abutment 27. In addition, the workpiece 5 or body 60 can be formed with a buccal contour 30 substantially the same as a final buccal contour 30. Thus, the buccal contour of the workpiece or body can have the same size, shape and contour as the final crown, or can be sized proportionally larger to shrink to the final size after heat hardening or sintering. The workpiece or substructure can comprise a pre-sintered dental ceramic material, such as zirconia. The workpiece or substructure can be cut or milled from a block of the pre-sintered dental ceramic material. Or the workpiece or substructure can be 3D printed. In addition, one or more pockets or holes 9 can be formed in the workpiece or body (such as in or about the mesial and/or distal side walls).

When a substructure 55′ (copying or framework) is formed, a body 60 can be veneered onto the substructure, and the one or more pockets or holes 9 can be formed in the body. The veneer can comprise a porcelain powder. The workpiece or body can have a buccal contour 30 substantially the same as the final crown by being the same shape, size and contour by: 1) being milled proportionally larger than the final crown, and then being shrunk during heat hardening (such as with zirconia); or 2) being veneered onto the substructure. The workpiece can then be sintered, defining a sintered workpiece 5; or the substructure can be sintered and body can be veneered and heat treated, to have substantially the final strength. The demineralization-inhibiting material 7 is applied to the pocket or hole 9, and the demineralization-inhibiting material is hardened or cured. The workpiece with the demineralization-inhibiting material, or the substructure and body with the demineralization-inhibiting material, forms the final crown 10 or 10b, or bridge 110 restoration. The final crown or bridge restoration can be mounted on the prepared tooth 2 or implant abutment 27.

In one aspect, the dental crown or bridge or in-lay or on-lay restoration can be modeled digitally based on a digitized scan of the patient's teeth, or a digitized scan of a model of the patient's teeth 1, or a digitized scan of a mold of the patient's teeth. In another aspect, the dental crown or bridge restoration can be made based on a physical model or dental stone model 1 of the patient's teeth. The model can be segmented to create a working die 4. The patient's tooth can be cut while in the patient's mouth to form a prepared or cut tooth 2. The model (physical or digital) can include the prepared or cut tooth 2 (with reference number 2 used herein to refer to both a cut tooth and a model of the cut tooth). The dental crown or bridge or in-lay or on-lay restoration can be formed outside of the patient's mouth based on the model (again physical or digital).

The dental prosthesis or restoration, or the dental crown 10 or 10b, or bridge 110 restoration, can have occlusal 15, mesial side 11, buccal 14, distal side 12, and lingual walls 13. The buccal wall 14 can be adjacent a patient's cheek. The lingual wall 13 can be adjacent a patient's tongue. The occlusal wall 15 can face an opposing tooth. The occlusal wall 15 can be solid between the concavity 16 and an exterior surface thereof, and can abut to the prepared tooth 2 or the implant abutment 27. The mesial and the distal side walls 11 and 12 can each face a different adjacent tooth 8 (with reference number 8 used herein to refer to both the adjacent teeth and a model of the adjacent teeth). The walls are connected to define a concavity 16 therein to receive and match the prepared tooth 2 or an implant abutment 27. The dental prosthesis or restoration, or the dental crown 10 or 10b, or bridge 110 restoration, can have a solid and continuous interface between the cut tooth 2 or the implant abutment 27, so that there is usually substantially no hollow between the cut tooth, or implant abutment, and the interior surface of the crown or bridge; and/or the interface being filled with epoxy.

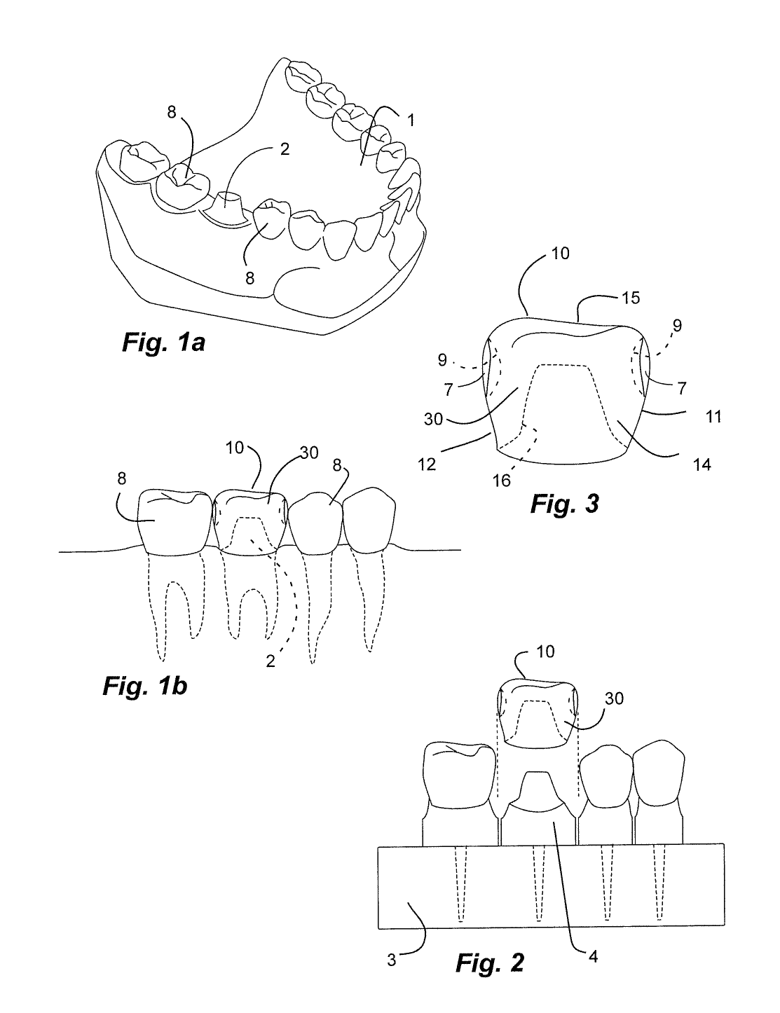

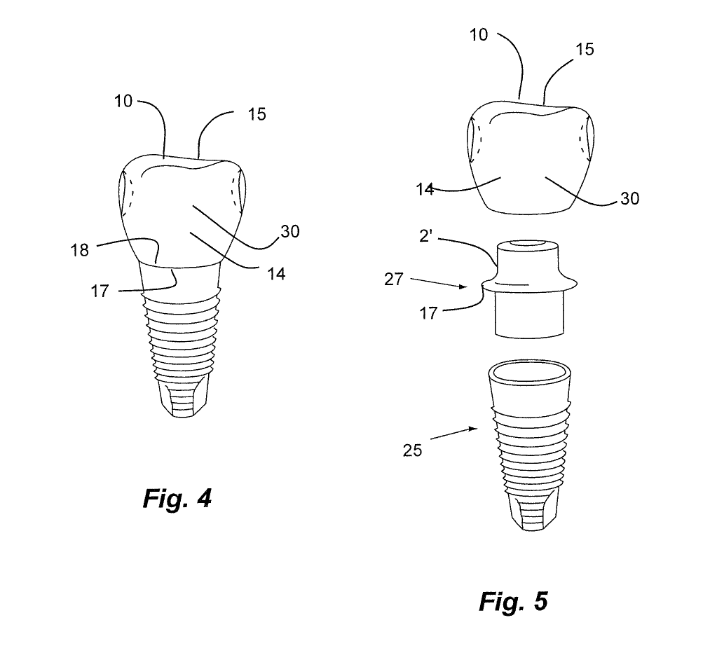

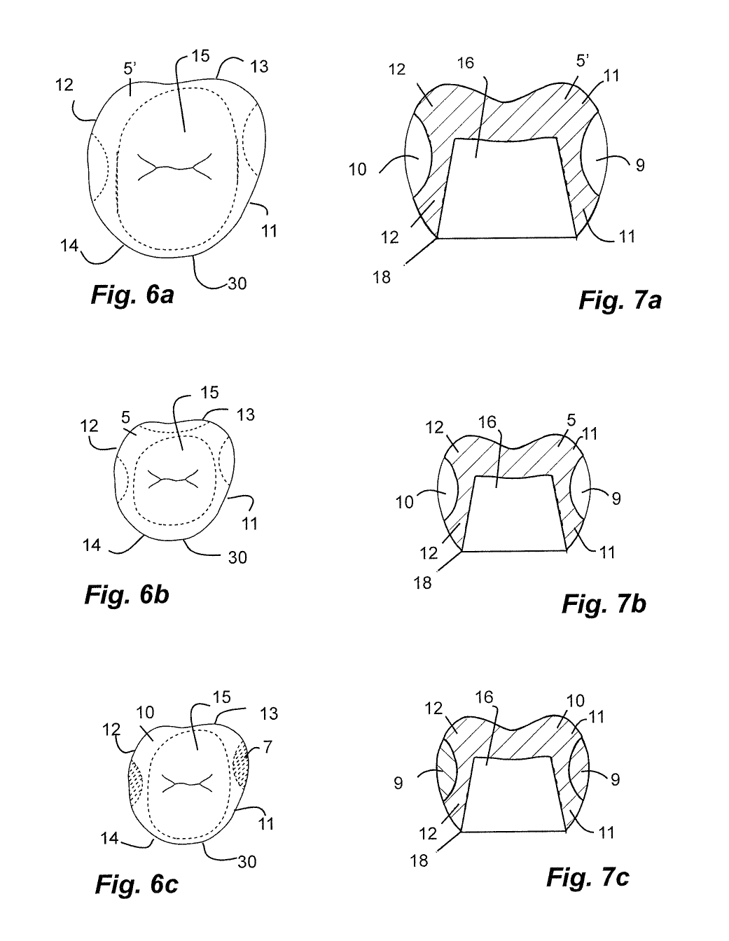

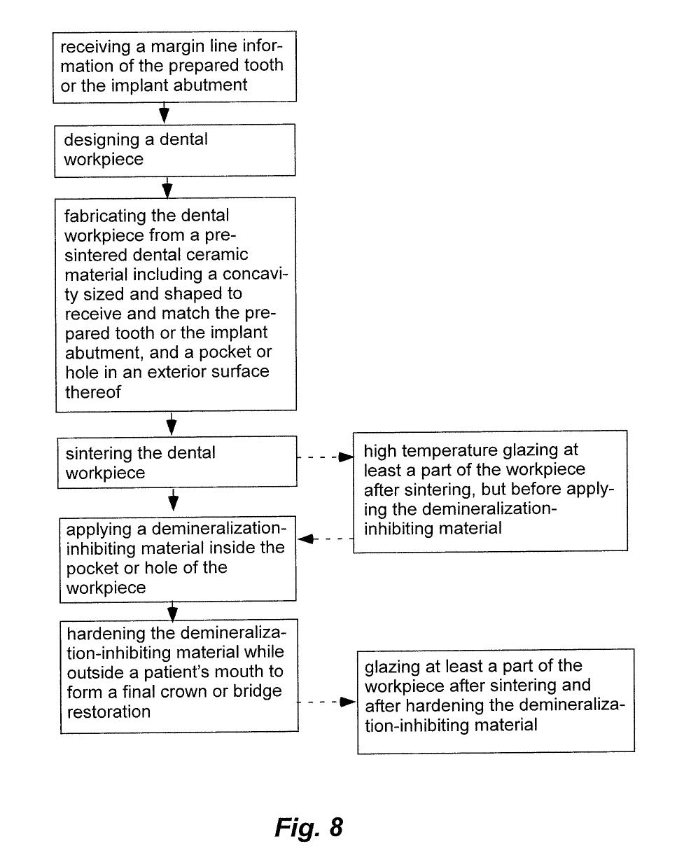

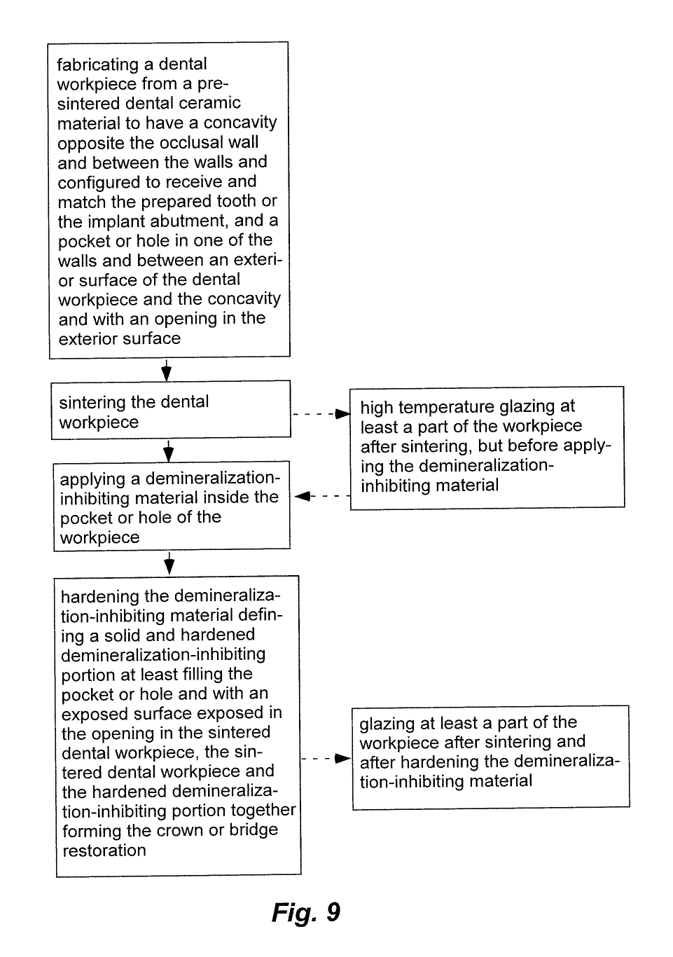

In one aspect, the method of making the dental crown or bridge restoration can include a plurality of sequential steps. In another aspect, the method can include various steps in any order. Referring to FIGS. 1-9, the method comprises receiving a margin line information regarding the margin line 17 of the prepared tooth 2 or the implant abutment 27. The margin line information can be obtained from a scan of the patient's teeth (and thus a scan of the cut or prepared tooth, or the implant abutment, and the adjacent teeth), a mold of the patient's teeth (and thus a mold of the cut or prepared tooth, or the implant abutment, and the adjacent teeth; which can also be scanned), or model of the patient's teeth (and thus a model of the cut or prepared tooth, or the implant abutment, and the adjacent teeth; which can be formed from the mold, and which can be scanned).

Then (after receiving the margin line information), a dental workpiece 5′ is designed. The dental workpiece can be designed with a CAD system. The dental workpiece can be designed based on the margin line information and the adjacent teeth. In one aspect, the workpiece can substantially form the crown 10 or bridge 110 or in-lay or on-lay restoration. The workpiece can have the occlusal 15, mesial side 11, buccal 14, distal side 12, and lingual walls 13, and the concavity 16. The workpiece can have a buccal contour substantially the same as the final crown or bridge restoration. In another aspect, the workpiece can form a substructure. In another aspect, the workpiece can be an in-lay or an on-lay. The workpiece or substructure can be coping for a crown restoration, or a framework for a bridge restoration. The workpiece can have the concavity 16, and can receive porcelain body that can be veneered onto the substructure. The body can have the occlusal 15, mesial side 11, buccal 14, distal side 12, and lingual walls 13. In addition, the body can have a buccal contour substantially the same as the final crown or bridge restoration.

Then (after the dental workpiece is designed), the dental workpiece 5′ is fabricated from a pre-sintered dental ceramic material. In one aspect, the dental workpiece can be milled from the dental ceramic material, such as a zirconia block. In another aspect, the dental workpiece can be 3D printed. The dental workpiece 5′ can be fabricated to include the concavity 16 sized and shaped to receive and match the prepared tooth or the implant abutment. In addition, the dental workpiece can be fabricated to include the pocket or hole 9 in an exterior surface of the dental workpiece. In one aspect, the workpiece can be design and/or fabricated with the pocket or hole 9 on or around at least one of the mesial side wall 11 or the distal side wall 12 of the dental workpiece. The exterior surface can have an opening to the pocket or hole. In one aspect, the pre-sintered dental ceramic material can comprise at least one of zirconia (ZrO2), alumina (Al2O3), magnesia (MgO), titanic (TiO2), or mixtures thereof. In one aspect, the dental workpiece 5′ can be formed from the pre-sintered dental ceramic material in a proportional size larger than the final dental crown restoration or sintered dental workpiece to accommodate for volumetric shrinkage during sintering. The dental workpiece 5′ can be formed outside of the patient's mouth.

Then (after the dental workpiece is fabricated), the dental workpiece 5′ is sintered. During sintering, the workpiece can undergo a volumetric change in size, namely shrinking. Thus, the dental workpiece can be designed and fabricated to accommodate the shrinkage, namely by being designed and fabricated to have a larger size prior to sintering. Sintering can define a sintered dental workpiece 5, which can have the same size and hardness as the final dental crown restoration. Thus, the sintered dental workpiece can be sized and shaped to match the prepared tooth or implant abutment.

Then (after the dental workpiece is sintered), a demineralization-inhibiting material 7 is applied inside the pocket or hole 9 of the sintered workpiece 5. In one aspect, the demineralization-inhibiting material can at least fill the pocket or hole. Thus, the volume of the pocket or hole and the demineralization-inhibiting material can be substantially the same. The demineralization-inhibiting material can be exposed through the opening in the exterior surface to the pocket or hole. In one aspect, the demineralization-inhibiting material can further comprise a re-mineralization material. In another aspect, the demineralization-inhibiting material can comprise at least one of calcium ions, phosphate ions, fluoride ions, titania ions, iodine, chlorhexidine, glass ionomer, resin-modified glass ionomer, compomers, calcium phosphate, tri-calcium phosphate (TCP), tetracalcium phosphate (TTCP), dicalcium phosphate anhydrous (DCPA), amorphous calcium phosphate (ACP), calcium and phosphate fillers that release calcium and phosphate ions, silver ions, nano silver particles, silver zeolite, or combinations thereof. The demineralization-inhibiting material 7 can be applied to the pocket or hole 9 of the sintered workpiece 5 outside of the patient's mouth.

Then (after the demineralization-inhibiting material is applied inside the pocket or hole of the workpiece), the demineralization-inhibiting material 7 is hardened and/or cured while outside a patient's mouth. In one aspect, the demineralization-inhibiting material can be self-curing (and the method can include self-curing or hardening). In another aspect, the demineralization-inhibiting material can be light-cured (and the method can include light curing or hardening). In another aspect, the demineralization-inhibiting material can be heat-cured (and the method can include heat-curing or hardening). In another aspect, the demineralization-inhibiting material can be hardened or cured with combinations of the above. In one aspect, hardening the demineralization-inhibiting material 7 defines a solid and hardened demineralization-inhibiting portion at least filling the pocket or hole, and with an exposed surface exposed in an opening of the pocket or hole 9 in the sintered dental workpiece 5. Hardening or curing the demineralization-inhibiting material can form a final crown 10 or bridge 110 restoration. The dental prosthesis or restoration, or the dental crown 10 or 10b, or bridge 110 restoration, can be solid and continuous with the cut tooth 2 or the implant abutment 27 and an exterior thereof, with substantially no hollow between the cut tooth or implant abutment and the exterior surface of the crown or bridge. Thus, the demineralization-inhibiting material 7 can substantially file the pocket or hole 9, and can form at least a portion of the exterior surface of the crown or bridge. Thus, the crown or bridge eliminates any weak portions, or particle traps.

In one aspect, the method can further comprise seating and securing the final crown 10 or bridge 110 restoration on the prepared tooth 2 or implant abutment 27 inside the patient's mouth. In another aspect, the demineralization-inhibiting material 7 can have a contact relationship with an adjacent tooth 8 (as shown in FIG. 1b). Thus, the pocket or hole 9 can be designed and fabricated to position the pocket or hole adjacent or proximate an adjacent tooth 8, and thus position the demineralization-inhibiting material 7 or hardened demineralization-inhibiting portion or exposed surface thereof to abut to the adjacent tooth 8.

In another aspect, the pocket or hole 9, and/or the demineralization-inhibiting material 7, can be formed in another surface of the final crown 10 or bridge 110, or the prepared tooth, such as the buccal side, lingual side, and/or occlusal side.

In another aspect, the method can further comprise high temperature glazing at least a part of the workpiece after sintering, but before applying the demineralization-inhibiting material.

In another aspect, the method can further comprise glazing at least a part of the workpiece after sintering and after hardening the demineralization-inhibiting material.

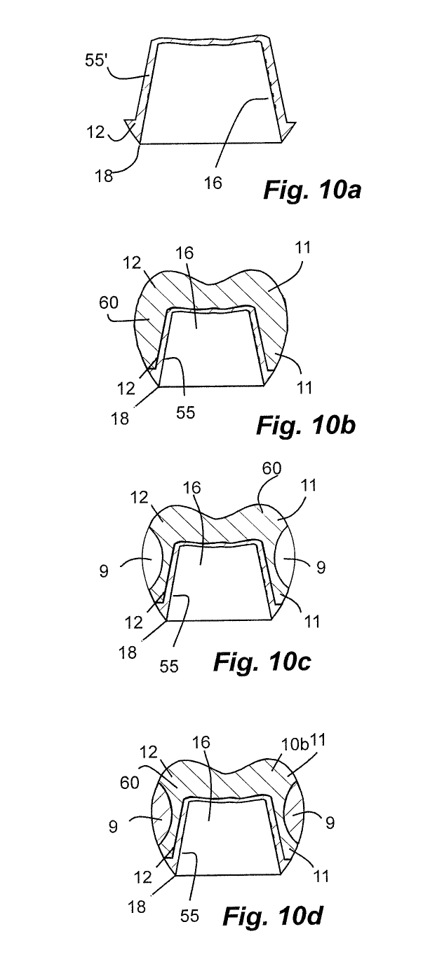

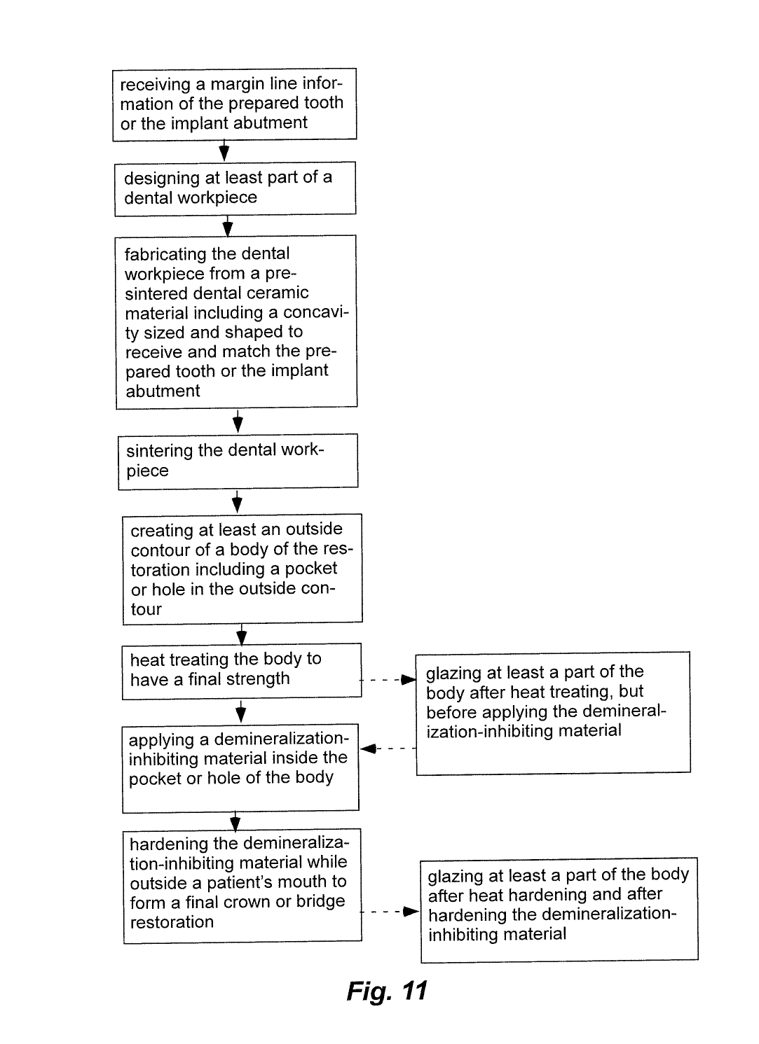

As discussed above, the dental workpiece can be a substructure 55′, such as a coping (for a crown) or a framework (for a bridge), and a body 60 can be veneered onto the substructure, and the one or more holes 9 can be formed in the body. Referring to FIGS. 1-5 and 10a-11, the method comprises receiving a margin line information regarding the margin line 17 of the prepared tooth 2 or the implant abutment 27. The margin line information can be obtained from a scan of the patient's teeth (and thus a scan of the cut or prepared tooth, or the implant abutment, and the adjacent teeth), a mold of the patient's teeth (and thus a mold of the cut or prepared tooth, or the implant abutment, and the adjacent teeth; which can also be scanned), or model of the patient's teeth (and thus a model of the cut or prepared tooth, or the implant abutment, and the adjacent teeth; which can be formed from the mold, and which can be scanned).

Then (after receiving the margin line information), at least part of a dental workpiece 55′, or substructure, coping or framework, is designed. The dental workpiece can be designed with a CAD system. The dental workpiece can be designed based on the margin line information. The dental workpiece, or substructure, coping or framework, can be designed with a concavity 16 to receive the prepared tooth or implant abutment.

Then (after the dental workpiece is designed), the dental workpiece 55′ is fabricated from a pre-sintered dental ceramic material. In one aspect, the dental workpiece can be milled from the dental ceramic material, such as a zirconia block. In another aspect, the dental workpiece can be 3D printed. The dental workpiece 55′ can be fabricated to include the concavity 16 sized and shaped to receive and match the prepared tooth or the implant abutment. In one aspect, the pre-sintered dental ceramic material can comprise at least one of zirconia (ZrO2), alumina (Al2O3), magnesia (MgO), titania (TiO2), or mixtures thereof. In one aspect, the dental workpiece 55′, or substructure, coping or framework, can be formed from the pre-sintered dental ceramic material in a proportional size larger than the final dental crown restoration or sintered dental workpiece to accommodate for volumetric shrinkage during sintering. The dental workpiece 55′, or substructure, coping or framework, can be formed outside of the patient's mouth.

Then (after the dental workpiece is fabricated), the dental workpiece 55′, or substructure, coping or framework, is sintered. During sintering, the workpiece can undergo a volumetric change in size, namely shrinking. Thus, the dental workpiece can be designed and fabricated to accommodate the shrinkage, namely by being designed and fabricated to have a larger size prior to sintering. Sintering can define a sintered dental workpiece 55, or substructure, coping or framework.

Then (after the dental workpiece is sintered), at least an outside contour of a body 60 of the restoration is created including a pocket or hole 9 in the outside contour. In addition, the dental workpiece can be fabricated to include the pocket or hole 9 in an exterior surface of the dental workpiece. In one aspect, creating the outside contour of the body can comprise veneering the dental workpiece 55, or the substructure, coping or framework. Veneering can comprise applying layers or veneers of porcelain. In one aspect, the body 60 can be created or veneered with the pocket or hole 9 therein. In another aspect, the pocket or hole 9 can be created in the body after the body is created or veneered. The pocket or hole 9 can be created or veneered on or around at least one of the mesial side wall 11 or the distal side wall 12 of the body. The exterior surface can have an opening to the pocket or hole. The body can be created or veneered on the dental workpiece 55, or substructure, coping or framework, outside of the patient's mouth.

Then (after the body is created or veneered), the body is heat treated to have a final strength.

Then (after the body is heat treated), a demineralization-inhibiting material 7 is applied inside the pocket or hole 9 of the body 60 and/or workpiece 55. In one aspect, the demineralization-inhibiting material can at least fill the pocket or hole. Thus, the volume of the pocket or hole and the demineralization-inhibiting material can be substantially the same. The demineralization-inhibiting material can be exposed through the opening in the exterior surface to the pocket or hole. In one aspect, the demineralization-inhibiting material can further comprise a re-mineralization material. In another aspect, the demineralization-inhibiting material can comprise at least one of calcium ions, phosphate ions, fluoride ions, titania ions, iodine, chlorhexidine, glass ionomer, resin-modified glass ionomer, compomers, calcium phosphate, tri-calcium phosphate (TCP), tetracalcium phosphate (TTCP), dicalcium phosphate anhydrous (DCPA), amorphous calcium phosphate (ACP), calcium and phosphate fillers that release calcium and phosphate ions, silver ions, nano silver particles, silver zeolite, or combinations thereof. The demineralization-inhibiting material 7 can be applied to the pocket or hole 9 of the body 60 and/or workpiece 55 outside of the patient's mouth.

Then (after the demineralization-inhibiting material is applied inside the pocket or hole of the body or workpiece), the demineralization-inhibiting material 7 is hardened and/or cured while outside a patient's mouth. In one aspect, the demineralization-inhibiting material can be self-curing (and the method can include self-curing or hardening). In another aspect, the demineralization-inhibiting material can be light-cured (and the method can include light curing or hardening). In another aspect, the demineralization-inhibiting material can be heat-cured (and the method can include heat-curing or hardening). In another aspect, the demineralization-inhibiting material can be hardened or cured with combinations of the above. In one aspect, hardening the demineralization-inhibiting material 7 defines a solid and hardened demineralization-inhibiting portion at least filling the pocket or hole, and with an exposed surface exposed in an opening of the pocket or hole 9 in the body 60 or dental workpiece 55. Hardening or curing the demineralization-inhibiting material can form a final crown 10b (or bridge 110 restoration).

In another aspect, the method can further comprise glazing at least a part of the workpiece or body after heat treating, but before applying the demineralization-inhibiting material.

In another aspect, the method can further comprise glazing at least a part of the workpiece after heat treating and after hardening the demineralization-inhibiting material.

Referring to FIG. 12, a method for forming the pocket or hole 9 is shown with respect to the dental workpiece 5′ in which a dental tool 91 or cutting bur thereof is used to mill the pocket or hole. In addition, the pocket or hole 9 can have an undercut 90 so that an interior of the pocket or hole 9 is greater or sized larger than the opening thereto.

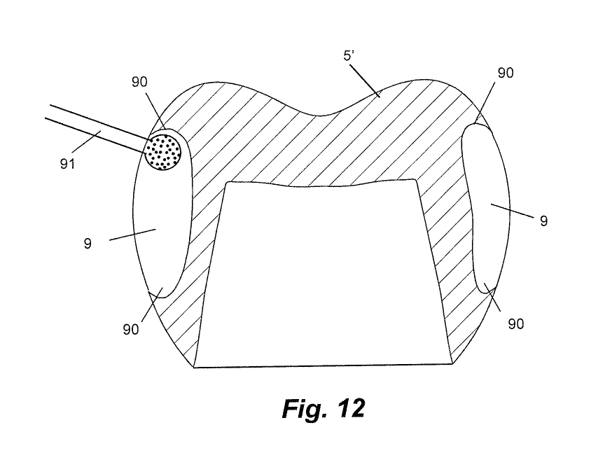

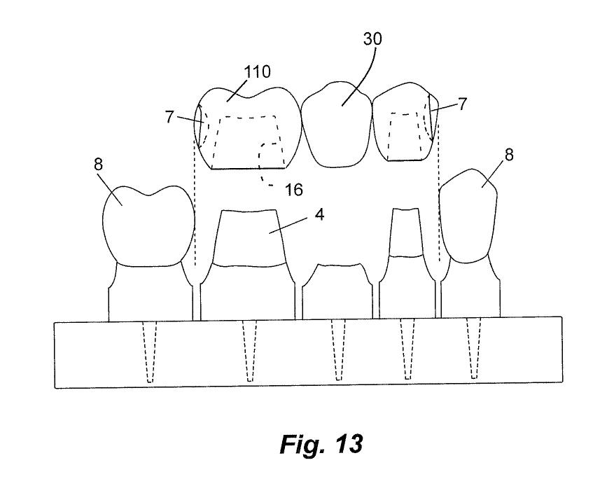

Referring to FIG. 13, a dental prosthesis, namely a bridge 110 restoration, is shown fabricated by any of the methods outlined above.

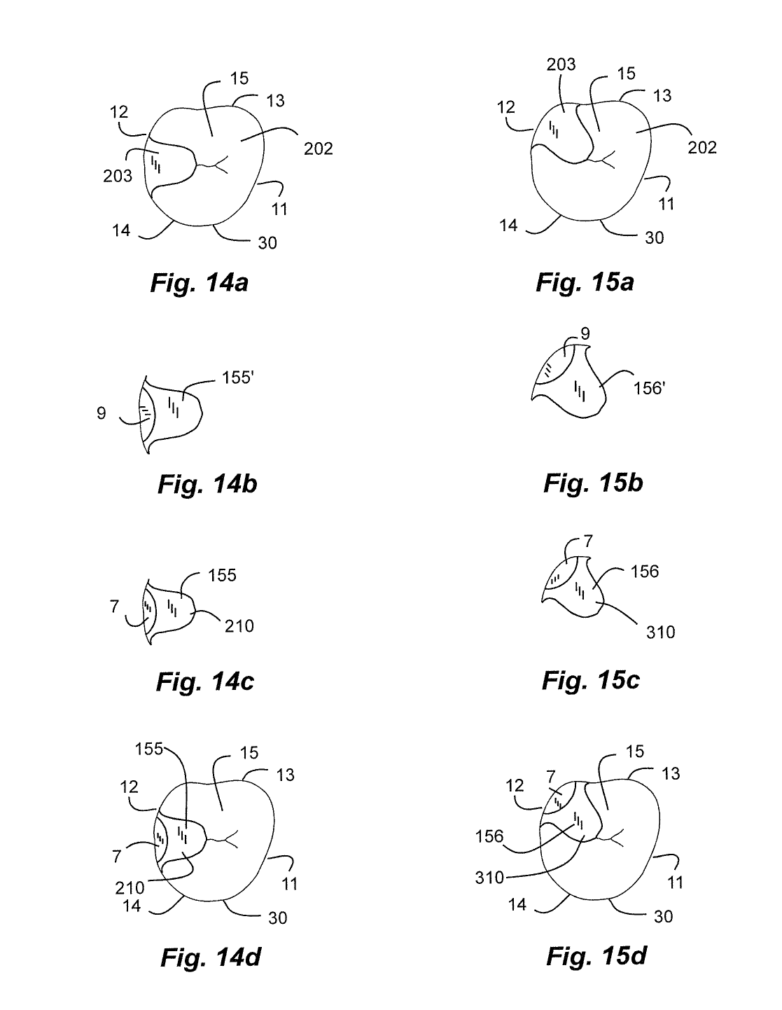

As discussed above, the dental prosthesis or restoration can be an in-lay or on-lay, ans such description is hereby incorporated herein by reference. Referring to FIGS. 14a-15d, the method comprises receiving a margin line information regarding the margin line of the prepared tooth 202. The margin line information can be obtained from a scan of the patient's teeth (and thus a scan of the cut or prepared tooth, or the impland abutment, and the adjacent teeth), a mold of the patient's teeth (and thus a mold of the cut or prepared tooth, or the implant abutment, and the adjacent teeth; which can also be scanned), or model of the patient's teeth (and thus a model of the cut or prepared tooth, or the implant abutment, and the adjacent teeth; which can be formed from the mold, and which can be scanned). The prepared tooth 202 can be cut to have an indentation 203 or cut-out therein, as shown in FIGS. 14a and 15a.

Then (after receiving the margin line information), a dental workpiece 155′ or 156′ is designed. The dental workpiece can be designed with a CAD system. The dental workpiece can be designed based on the margin line information and the adjacent teeth. In one aspect, the workpiece can substantially form the in-lay 155 or on-lay 156 restoration.

Then (after the dental workpiece is designed), the dental workpiece 155′ or 156′ is fabricated from a pre-sintered dental ceramic material, as shown in FIGS. 14b and 15b. In one aspect, the dental workpiece can be milled from the dental ceramic material, such as a zirconia block. In another aspect, the dental workpiece can be 3D printed. The dental workpiece 155′ or 156′ can be fabricated to be sized and shaped to match the prepared tooth or the indentation or cut-out thereof. In addition, the dental workpiece can be fabricated to include the pocket or hole 9 in an exterior surface of the dental workpiece. In one aspect, the workpiece can be design and/or fabricated with the pocket or hole 9 on or around at least one of the mesial side wall 11 or the distal side wall 12 of the dental workpiece or corresponding to the prepared tooth. The exterior surface can have an opening to the pocket or hole. In one aspect, the pre-sintered dental ceramic material can comprise at least one of zirconia (ZrO2), alumina (Al2O3), magnesia (MgO), titania (TiO2), or mixtures thereof. In one aspect, the dental workpiece 155′ or 156′ can be formed from the pre-sintered dental ceramic material in a proportional size larger than the final in-lay or on-lay restoration or sintered dental workpiece to accommodate for volumetric shrinkage during sintering. The dental workpiece can be formed outside of the patient's mouth.

Then (after the dental workpiece is fabricated), the dental workpiece 155′ or 156′ is sintered. During sintering, the workpiece can undergo a volumetric change in size, namely shrinking. Thus, the dental workpiece can be designed and fabricated to accommodate the shrinkage, namely by being designed and fabricated to have a larger size prior to sintering. Sintering can define a sintered dental workpiece 155 or 156, which can have the same size and hardness as the final dental crown restoration.

Then (after the dental workpiece is sintered), a demineralization-inhibiting material 7 is applied inside the pocket or hole 9 of the sintered workpiece 155 or 156, as shown in FIGS. 14c and 15c. In one aspect, the demineralization-inhibiting material can at least fill the pocket or hole. Thus, the volume of the pocket or hole and the demineralization-inhibiting material can be substantially the same. The demineralization-inhibiting material can be exposed through the opening in the exterior surface to the pocket or hole. The demineralization-inhibiting material 7 can be applied to the pocket or hole 9 of the sintered workpiece outside of the patient's mouth.

Then (after the demineralization-inhibiting material is applied inside the pocket or hole of the workpiece), the demineralization-inhibiting material 7 is hardened and/or cured while outside a patient's mouth. Hardening or curing the demineralization-inhibiting material can form a final in-lay 210 or on-lay 310 restoration.

In one aspect, the method can further comprise seating and securing the final in-lay 210 or on-lay 310 restoration on the prepared tooth 202, or indentation or cut-out 203 thereof, inside the patient's mouth.

In another aspect, the in-lay or on-lay restoration can have a substructure and body as described above.

Although preferred embodiments of the invention have been described using specific terms, devices, and methods, such description are for illustrative purposes only. The words used are words of description rather than of limitation. It is to be understood that changes and variations may be made by those of ordinary skill in the art without departing from the spirit or the scope of the present invention which is set forth in the following claims. In addition, it should be understood that aspects of the various embodiments may be interchanged, both in whole, and in part. Therefore, the spirit and scope of the appended claims should not be limited to the description of the preferred versions contained therein.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A method for making a dental restoration configured to receive and match a prepared tooth or an implant abutment, the method comprising, in sequence, the steps of:
a) receiving a margin line information of the prepared tooth or the implant abutment; followed by
b) designing a dental workpiece; followed by
c) fabricating the dental workpiece from a pre-sintered dental ceramic material shaped to match the prepared tooth or the implant abutment, and a pocket or hole in an exterior surface thereof; followed by
d) sintering the dental workpiece; followed by
e) applying a demineralization-inhibiting material inside the pocket or hole of the workpiece; followed by
f) hardening the demineralization-inhibiting material while outside a patient's mouth to form a final restoration.

2. The method in accordance with claim 1, wherein the pre-sintered dental ceramic material further comprises at least one of zirconia (ZrO2), alumina (Al2O3), magnesia (MgO), Titania (TiO2), or mixtures thereof.

3. The method in accordance with claim 1, wherein the demineralization-inhibiting material comprises at least one of calcium ions, phosphate ions, fluoride ions, titania ions, iodine, chlorhexidine, glass ionomer, resin-modified glass ionomer, compomers, calcium phosphate, tri-calcium phosphate (TCP), tetracalcium phosphate (TTCP), dicalcium phosphate anhydrous (DCPA), amorphous calcium phosphate (ACP), calcium and phosphate fillers that release calcium and phosphate ions, silver ions, nano silver particles, silver zeolite, or combinations thereof.

4. The method in accordance with claim 1, wherein the demineralization-inhibiting material further comprises a re-mineralization material.

5. The method in accordance with claim 1, further comprising:
high temperature glazing at least a part of the workpiece after sintering, but before applying the demineralization-inhibiting material.

6. The method in accordance with claim 1, further comprising:
glazing at least a part of the workpiece after sintering and after hardening the demineralization-inhibiting material.

7. The method in accordance with claim 1, further comprising:
seating and securing the final restoration on the prepared tooth or implant abutment inside the patient's mouth with the demineralization-inhibiting material having a contact relationship with an adjacent tooth.

8. The method in accordance with claim 1, wherein fabricating the dental workpiece from the pre-sintered dental ceramic material with the pocket or hole in the exterior surface thereof further comprises fabricating the pocket or hole on or around at least one of a mesial side wall or a distal side wall of the dental workpiece.

9. The method in accordance with claim 1, wherein hardening the demineralization-inhibiting material defines a solid and hardened demineralization-inhibiting portion at least filling the pocket or hole and with an exposed surface exposed in an opening of the pocket or hole in the sintered dental workpiece.

10. A method for making a dental restoration configured to receive and match a prepared tooth or an implant abutment, the method comprising, in sequence, the steps of:
a) receiving a margin line information of the prepared tooth or the implant abutment; followed by
b) designing at least part of a dental workpiece; followed by
c) fabricating the dental workpiece from a pre-sintered dental ceramic material shaped to match the prepared tooth or the implant abutment; followed by
d) sintering the dental workpiece; followed by
e) creating at least an outside contour of a body of the restoration including a pocket or hole in the outside contour; followed by
f) heat treating the body to have a final strength; followed by
g) applying a demineralization-inhibiting material inside the pocket or hole of the body; followed by
h) hardening the demineralization-inhibiting material while outside a patient's mouth to form a final restoration.

11. The method in accordance with claim 10, wherein the pre-sintered dental ceramic material further comprises at least one of zirconia (ZrO2), alumina (Al2O3), magnesia (MgO), Titania (TiO2), or mixtures thereof.

12. The method in accordance with claim 10, wherein the demineralization-inhibiting material comprises at least one of calcium ions, phosphate ions, fluoride ions, titania ions, iodine, chlorhexidine, glass ionomer, resin-modified glass ionomer, compomers, calcium phosphate, tri-calcium phosphate (TCP), tetracalcium phosphate (TTCP), dicalcium phosphate anhydrous (DCPA), amorphous calcium phosphate (ACP), calcium and phosphate fillers that release calcium and phosphate ions, silver ions, nano silver particles, silver zeolite, or combinations thereof.

13. The method in accordance with claim 10, wherein the demineralization-inhibiting material comprises further comprises a re-mineralization material.

14. The method in accordance with claim 10, further comprising:
glazing at least a part of the body after heat treating, but before applying the demineralization-inhibiting material.

15. The method in accordance with claim 10, further comprising:
glazing at least a part of the body after heat hardening and after hardening the demineralization-inhibiting material.

16. The method in accordance with claim 10, wherein fabricating the workpiece comprises fabricating a coping or a framework; and wherein creating the outside contour of the body comprises veneering the coping or the framework.

17. The method in accordance with claim 10, further comprising:
seating and securing the final restoration on the prepared tooth or implant abutment inside the patient's mouth with the demineralization-inhibiting material having a contact relationship with an adjacent tooth.

18. The method in accordance with claim 10, wherein creating the outside contour of the body with the pocket or hole further comprises creating the pocket or hole on or around at least one of a mesial side wall or a distal side wall of the restoration.

19. The method in accordance with claim 10, wherein hardening the demineralization-inhibiting material defines a solid and hardened demineralization-inhibiting portion at least filling the pocket or hole and with an exposed surface exposed in an opening of the pocket or hole in the body.

20. A method for making a dental crown or bridge restoration configured to receive and match a prepared tooth or an implant abutment, the method comprising:
a) fabricating a dental workpiece from a pre-sintered dental ceramic material to have occlusal, mesial side, buccal, distal side, and lingual walls, with the buccal wall configured to be adjacent a patient's cheek, and the lingual wall configured to be adjacent a patient's tongue, the occlusal wall configured to face an opposing tooth, the mesial and the distal side walls each configured to face a different adjacent tooth, and a margin line configured to match a margin line of the prepared tooth or the implant abutment, and a concavity opposite the occlusal wall and between the walls and configured to receive and match the prepared tooth or the implant abutment, and a pocket or hole in one of the walls and with an opening in the exterior surface;
b) sintering the dental workpiece defining a sintered dental workpiece;
c) applying a demineralization-inhibiting material inside the pocket or hole of the workpiece; and
d) hardening the demineralization-inhibiting material defining a solid and hardened demineralization-inhibiting portion at least filling the pocket or hole and with an exposed surface exposed in the opening in the sintered dental workpiece, the sintered dental workpiece and the hardened demineralization-inhibiting portion together forming the crown or bridge restoration.

21. The method in accordance with claim 20, wherein the occlusal wall is solid between the concavity and an exterior surface thereof and is configured to abut to the prepared tooth or the implant abutment.
